(19) United States
(12) Patent Application Publication
(10) Pub. No.: US 2017/0170459 A1
(43) Pub. Date: Jun. 15, 2017

(54) METHOD OF MAKING ELECTRODES CONTAINING CARBON SHEETS DECORATED WITH NANOSIZED METAL PARTICLES AND ELECTRODES MADE THEREFROM

(71) Applicant: Purdue Research Foundation, West Lafayette, IN (US)

(72) Inventors: Vilas Ganpat Pol, West Lafayette, IN (US); Vinodkumar Etacheri, Iritty (IN)

(73) Assignee: Purdue Research Foundation, West Lafayette, IN (US)

(21) Appl. No.: 15/377,661

(22) Filed: Dec. 13, 2016

Related U.S. Application Data
(60) Provisional application No. 62/267,744, filed on Dec. 15, 2015.

(51) Int. Cl. H01M 4/36; H01M 4/04; H01M 4/587; H01M 10/0525; H01M 4/38

(52) U.S. Cl. CPC H01M 4/362; H01M 10/0525; H01M 4/38; H01M 4/587; H01M 4/0471; H01M 2004/021

(57) ABSTRACT

A method of making carbon sheets comprising nanosized metal particle. The method includes dissolving sodium chloride, a salt containing the metal, and glucose into water, maintaining weight ratio weight of sodium chloride to glucose in the range of 1-8, resulting in a homogeneous aqueous solution. The homogeneous aqueous solution is then dried to form a homogeneous powder which is then heated for a time period resulting in a composite comprising carbon sheets containing the sodium chloride and nanoparticles of the metal. The sodium chloride is removed resulting in carbon sheets containing nanoparticles of the metal. A carbon sheet with 2D morphology containing nanosized metal particles. An electrode comprising a carbon sheet with 2D morphology containing nanosized metal particles. An electrochemical storage cell containing an anode comprising a carbon sheet with 2D morphology containing nanosized metal particles.

### CROSS-REFERENCE TO RELATED APPLICATIONS

The present U.S. patent application is related to and claims the priority benefit of U.S. Provisional Patent Application Ser. No. 62/267,744, filed Dec. 15, 2015, the contents of which are hereby incorporated by reference in its entirety into the present disclosure.

### TECHNICAL FIELD

This disclosure relates to methods of improving the electrochemical energy storage performance of electrochemical cells, especially Li-ion cells, and especially by controlling the porosity of electrodes.

### BACKGROUND

This section introduces aspects that may help facilitate a better understanding of the disclosure. Accordingly, these statements are to be read in this light and are not to be understood as admissions about what is or is not prior art.

Rechargeable Li-ion batteries are the most promising power sources in current generation of portable electronics, medical devices and electric vehicles. Despite several advantages, their energy density, and rate performance are not sufficient to meet the power requirements of next generation power devices and electric vehicles. The poor electrochemical performance of graphite anodes in current generation Li-ion batteries at high charge-discharge rates due to slow Li⁺ diffusion is well known. These carbonaceous electrodes composed of ordered graphitic layers limit the energy/power density due to limited Li-storage (theoretical capacity of 372 mAh/g). Additionally, lithiation of graphite anodes at potentials (<0.3 V vs Li⁺/Li) close to Li-deposition voltage could cause Li-dendrite growth and related short circuit. In order to mitigate these safety/stability issues and to improve the energy density, immense efforts have been dedicated for the development of alternative high-capacity transition metal oxide anodes.

A number of transition metal oxides such as SnO₂, Fe₂O₃, Co₃O₄, NiO, MnO₂, MoO₃, WO₃ etc. are established as high-capacity anodes for Li-ion batteries. Cobalt oxide (Co₃O₄), a P-type semiconductors is a capable anode material due to its high theoretical capacity (890 mAh/g). However, Co₃O₄ particles undergo huge volume change (up to ≈300%) and severe particle aggregation during lithiation-delithiation cycles. Other shortcomings of Co₃O₄ anodes include poor electronic conductivity and loss of inter-particle contact during charge-discharge process. This causes the rapid fading of charge capacity and low coulombic efficiency on extended cycling. Lithiation of Co₃O₄ is accompanied by the unavoidable formation of Li₂O (Co₃O₄+8e+8Li⁺ [symbol] 4Li₂O+3Co), a poor electronic conductor. This causes an impedance increase, which deteriorates the electrochemical performance at high charge-discharge rates. Li₂O formation is also identified as a key reason for the large irreversible capacity loss of Co₃O₄ anodes. A number of studies have been carried out for improving the electrochemical performance of Co₃O₄ based anodes. Key requirements for attaining superior electrochemical performance are enhanced electronic and ionic conductivities. One of the established method for enhancing the Li-diffusion kinetics and electronic conductivity is the fabrication of nanostructures such as nanoparticles, nanotubes, nanowires, hollow spheres, and hexagonal cages. Due to unique electronic properties of 2D morphology, Co₃O₄ nanosheets and nano-flakes often outperformed other nanostructured anodes in Li-ion batteries.

Controlling the porosity was also found to have a noteworthy effect on the electrochemical performance. For instance, mesoporous Co₃O₄ electrodes exhibited improved electrochemical performance due to superior contact with the electrolyte solution. The word mesoporous is used here to mean pore diameters in the range of 2-50 nm. Another strategy is composite formation with electronically conducting substrates such as carbon nanotubes, graphene and carbon fibers. This method often resulted in reduced particle agglomeration and improved electronic conductivity, which are advantageous for superior electrochemical performance. Most of these synthetic methods utilize complex and expensive methods that are industrially nonviable. None of the strategies mentioned above eliminated the undesired formation of Li₂O during the lithiation of Co₃O₄. Despite of the several advances in the fabrication of transition metal oxide based anodes, obtaining stable cycling performance and good rate performance of Co₃O₄ electrodes still remains as a great challenge.

Hence there is an unmet need for stable cycling performance and good rate performance of cobalt-containing electrodes. Further, it is desirable that methods that achieve these objectives be scalable and include relatively inexpensive synthesis along with excellent electrochemical performance and mechanical stability and chemical stability.

### SUMMARY

A method of making carbon sheets comprising nanosized metal particles is disclosed. The method includes dissolving a quantity of sodium chloride, a quantity of a salt containing the metal, and a quantity of glucose into water, such that the ratio of weight of sodium chloride and the weight of glucose is in the range of 1 to 8, resulting in a homogeneous aqueous solution of sodium chloride, glucose and the salt of the metal. The homogeneous aqueous solution is then dried at a temperature in the range of 80-100° C., resulting in a homogeneous powder containing the sodium chloride, the glucose and the salt of the metal. The homogeneous powder is then heated at a heating temperature in an inert atmosphere for a time period resulting in a composite comprising carbon sheets containing the sodium chloride and nanoparticles of the metal. The composite containing carbon sheet containing the sodium chloride and nanoparticles of the metal is then cooled to room temperature and the sodium chloride is removed by dissolving the composite in water resulting in carbon sheets containing nanoparticles of the metal.

A carbon sheet with 2D morphology containing nanosized metal particles is disclosed.

An electrode comprising a carbon sheet with 2D morphology containing nanosized metal particles is disclosed.

An electrochemical storage cell containing an anode comprising a carbon sheet with 2D morphology containing nanosized metal particles is disclosed.

### BRIEF DESCRIPTION OF DRAWINGS

Some of the figures shown herein may include dimensions. Further, some of the figures shown herein may have been created from scaled drawings or from photographs that are scalable. It is understood that such dimensions or the relative scaling within a figure are by way of example, and not to be construed as limiting.

FIG. 1 is a schematic representation of synthesis of cobalt (Co) nano particles chemically bonded to porous carbon nanosheets.

FIG. 2A shows -ray diffraction pattern of Co-nanoparticles chemically bonded to porous carbon nanosheets.

FIG. 2B shows Raman spectra of Co-nanoparticles chemically bonded to porous carbon nanosheets.

FIGS. 3A through 3D show Scanning electron microscopy (SEM) images of Co@PCNS made by methods of this disclosure at various magnifications.

FIG. 3E is a high-resolution SEM of Co@PCNS made by methods of this disclosure.

FIGS. 4A through 4D show images at various magnifications of Co@PCNS made utilizing the method of this disclosure (as schematically illustrated in FIG. 1)

FIGS. 4E and 4F show AFM images of Co-nanoparticles chemically bonded to porous carbon nanosheets.

FIG. 5A shows XPS high-resolution spectra of Co₃O₄, Co-PCNS and Co@PCNS of sample C 1s.

FIG. 5B shows XPS high-resolution spectra of Co₃O₄, Co-PCNS and Co@PCNS of sample Co 2p.

FIG. 6A shows N₂ adsorption-desorption isotherm and pore size distribution (inset) of Co-nanoparticles chemically bonded to porous carbon nanosheets.

FIG. 6B shows thermogravimetric analysis {graph labeled (i)} and differential thermal analysis {graph labeled (ii)}of Co@PCNS gel under N₂ atmosphere at a heating rate of 10° C./min.

FIG. 7A shows second galvanostatic voltage profiles of Co@PCNS.

FIG. 7B shows second cycle cyclic voltammetry of Co@PCNS, Co3O4, and Co-PCNS.

FIG. 7C shows electrochemical rate performance of Co@PCNS, Co3O4, and Co-PCNS.

FIG. 7D shows galvanostatic cycling performance of Co@PCNS at various current densities.

FIG. 8A shows galvanostatic cycling stability of Co@PCNS, Co3O4, and Co-PCNS electrodes at 1C rate.

FIG. 8B shows electrochemical impedance spectra of Co@PCNS, Co3O4, and Co-PCNS electrodes.

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended.

In this disclosure a facile strategy and method for substantially improving the Li-ion storage performance of Co-based anodes by chemically bonding Co nanoparticles on porous carbon nanosheets is described. This method combines the advantages of ultrafine particle size, Co—C bonds, metal nanoparticles (to avoid Li₂O formation), mesoporous microstructure and 2D morphology. For purposes of this disclosure 2D morphology is to be understood to mean structures such as sheets that have a thickness generally not greater than 120 nm. Also described in this disclosure are electrodes with 2D morphology that contain carbon sheets with decorated metal particles. Electrochemical cells utilizing electrodes containing carbon sheets with 2D morphology containing metal particles. In the present disclosure sizes and or size ranges are given for particles including nanoparticles. Since the particles mentioned or obtained in the experiments of this disclosure or described in this disclosure are generally of irregular shape, it is to be understood that numbers given for size and size ranges refer to the largest dimension of a single particle. Also, for purposes of this disclosure “nanosized” is used to indicate sizes in the range of 5-30 nm. Further, for purposes of this disclosure, “nanoparticles” is used to describe particles in the size range of 1-100 nm.

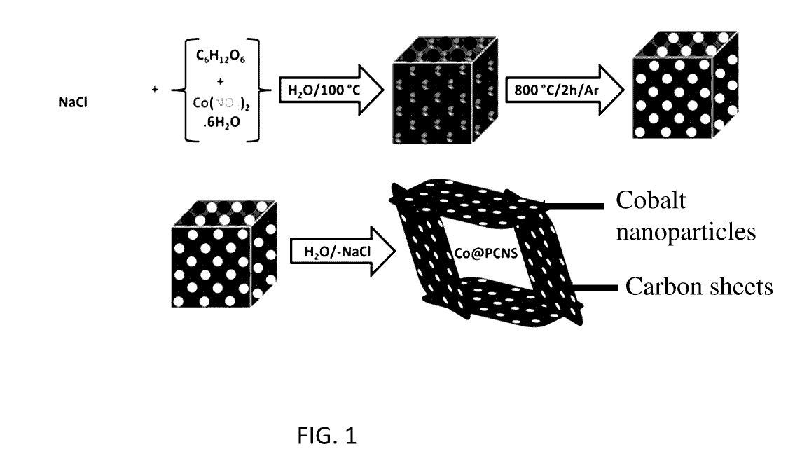

FIG. 1 is a schematic representation of synthesis of cobalt (Co) nano particles chemically bonded to porous carbon nanosheets. {Vilas: Define nanosheets} Nanosheet morphology is created by the use of NaCl template, as schematically shown in FIG. 1. Referring to FIG. 1, Co nanoparticles and Co—C bonds are created from the in-situ decomposition and carbothermal reduction of Co(NO₃)₂.6H₂O at about 800° C. Co nanoparticles obtained by this method are 20-30 nm in size and are uniformly anchored on porous carbon nanosheets through Co—C bonds. These chemically bonded 2D hybrid anodes exhibited excellent specific capacities, rate performance and long-term cycling stability compared to Co₃O₄ nanoparticles and a physical mixture of Co-nanoparticles and porous carbon nanosheets. This disclosure highlights the importance of Co—C bonds for stabilizing the electrochemical performance of Co-based hybrid anodes for rechargeable Li-ion batteries.

In some of the experiments leading to this disclosure, Co@PCNS (where Co@PCNS stands for nanoparticles of cobalt chemically bonded to porous carbon nanosheets) samples were made. (Co@PCNS) were synthesized through NaCl-templated method, schematically represented in FIG. 1. In a typical synthesis, 1 g of cobalt (II) nitrate hexahydrate (Co(NO₃)₂.6H₂O) and 2 g of glucose (C₆H₁₂O₆) were completely dissolved in 20 mL deionized water. This solution was mixed with 15 g of sodium chloride (NaCl) followed by drying at 100° C. for 24 h. The obtained powder was then heat treated at 800° C. for 2 h under high-purity Argon atmosphere; heating and cooling rates were 10° C./min. Black colored power obtained was thoroughly washed with deionized water to remove NaCl and dried in a vacuum oven at 80° C. for 24 h to form Co@PCNS. For comparing the electrochemical performance, samples of physically mixed composite of Co-nanoparticles and porous carbon nanosheets were also prepared. This composite is denoted as (Co-PCNS). Co-PCNS samples were prepared by treating Co@PCNS with HCl (to remove Co nanoparticles) followed by washing, drying and mixing with purchased Co nanopartciles (20-50 nm in size). Phase pure Co₃O₄ nanoparticles were also prepared by oxidizing Co@PCNS at 600° C. for 2 h.

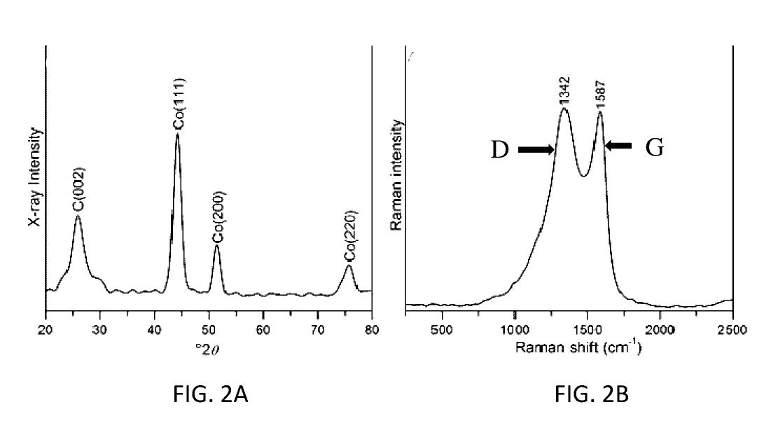

FIG. 2A shows X-ray diffraction (XRD) pattern of Co@PCNS (where Co@PCNS stands for Co-nanoparticles chemically bonded to porous carbon nanosheets). Referring to FIG. 2A, the XRD pattern displayed distinct peaks characteristic of face centered cubic (fcc) Co and disordered carbon. Average particle size calculation using Debye Scherrer equation indicated the formation of 25±5 nm sized Co nanoparticles. FIG. 2B shows Raman spectra of Co-nanoparticles chemically bonded to porous carbon nanosheets. This disorder nature of carbon sheets is beneficial for improved electrochemical performance and safety of Li-ion batteries (due to lithiation at higher voltage compared to graphitic carbon). Raman spectra also established the absence of Co-oxides in Co@PCNS that can possibly formed during the heat treatment of Co(NO₃)₂.6H₂O. XRD pattern and Raman spectrum of Co@PCNS prepared at 700° C. revealed the presence of CoO impurities, suggesting that a processing temperature of 800° C. ensures phase-pure fcc-cobalt nanoparticles. Carbon sheets containing CoO in addition to Co particles are still usable in extrudes for electrochemical cells; however the performance of such cells will be inferior to those without the presence of CoO.

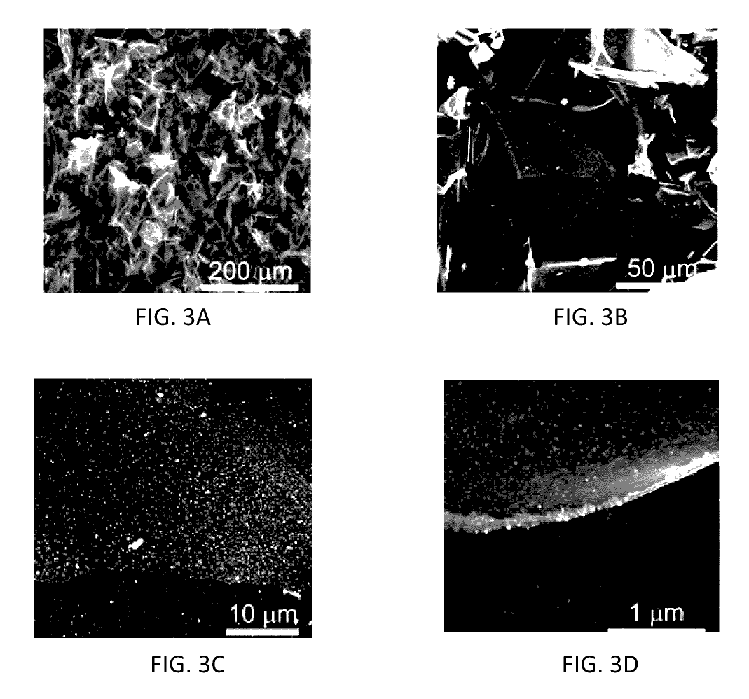

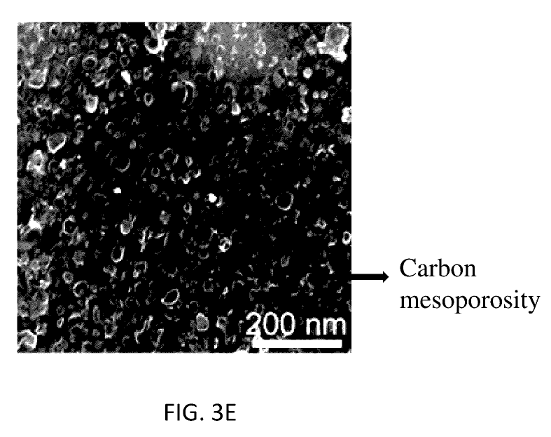

FIGS. 3A through 3D show Scanning electron microscopy (SEM) images of Co@PCNS made utilizing the method of this disclosure (as schematically illustrated in FIG. 1) at various magnifications. FIGS. 3A through 3D validate formation of carbon nanosheets with very low degree of agglomeration and illustrate that these nanosheets of 50-100 μm length and 100±5 nm thicknesses are uniformly decorated with 25±5 nm sized Co nanoparticles. For purposes of this disclosure the word “decorate” is used to mean creating presence of metal particles on a carbon sheet that are either mechanically or chemically attached to the carbon sheet. FIG. 3E is a high-resolution SEM of Co@PCNS made by methods of this disclosure. Referring to FIG. 3E, mesoporosity of individual carbon nanosheets is observed. Energy Dispersive Analysis and mapping using SEM images has demonstrated not only compositional uniformity of Co@PCNS but also homogeneous distribution of Co nanoparticles attributable to the molecular level mixing of the carbon and cobalt precursors.

In order to investigate the effect of Co-precursor on the Co@PCNS microstructure, samples are also prepared with Co(CH₃COO)₂.4H₂O, instead of using cobalt nitrate. In this case, carbon nanosheets appeared to be non-porous, confirming the fact that in-situ decomposition of nitrate ions is a key factor governing the porosity of carbon nanosheets. It should be noted that in experiments leading to this disclosure, morphological analysis of Co—C composites prepared without using NaCl did not show the 2D morphology found in the samples prepared using NaCl. This verified that the desirable 2D nanosheet morphology is attributable to the use of NaCl, where micron-sized walls of the NaCl act as template for carbon nanosheets.

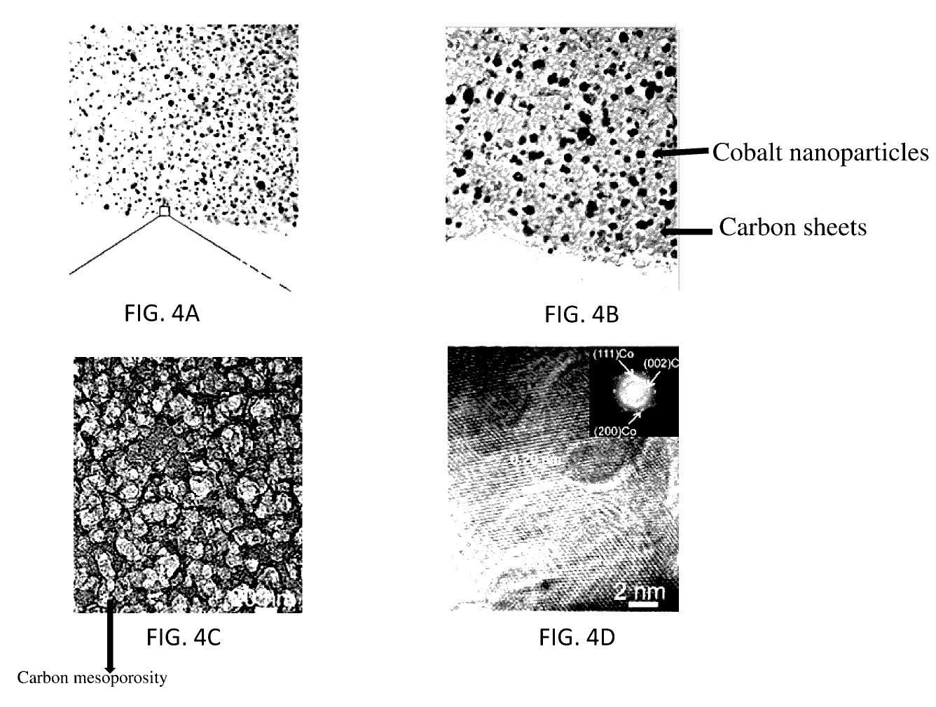

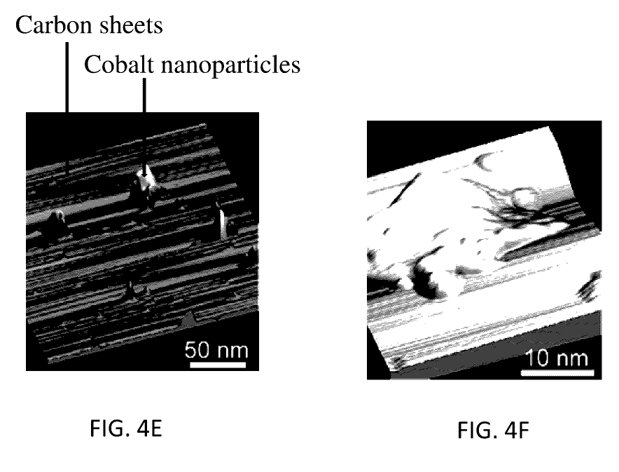

Additional microstructural characterizations are carried out using transmission electron microscopy (TEM) and atomic force microscopy (AFM). FIGS. 4A through 4D show TEM images at various magnifications of Co@PCNS made utilizing the method of this disclosure (as schematically illustrated in FIG. 1. Referring to FIGS. 4A through 4D, one can confirm the nanosheet morphology and mesoporous microstructure of Co@PCNS sample made by the methods of this disclosure. In FIGS. 4A and 4B, dark spots correspond to metallic cobalt nano particles, while the background for these dark spots represents carbon sheet. Average size of Co nanoparticles (25±5 nm) measured from these TEM images are in good agreement with SEM and XRD results. FIG. 4C is a magnified image of an area indicated by a square in the carbon sheet in FIG. 4A by two lines drawn meeting at the area, indicating porosity in the range of 10-25 nm in the carbon sheet. Selected area electron diffraction (SAED) pattern of Co@PCNS is presented in the inset of FIG. 4D, which can be indexed to (111) and (200) planes of fcc-Co and (002) plane of disordered carbon. The high-resolution TEM image in FIG. 4D further shows the single crystalline nature of Co with an inter-planar spacing of 0.20 nm. FIGS. 4E and 4F show contact mode Atomic Force Microscope (AFM) images which show that individual Co nanoparticles are strongly anchored on carbon nano sheets. These Co nanoparticles retained their morphology and remained well tethered even after several AFM scans, indicating their robust nature and strong bonding to carbon nanosheets.

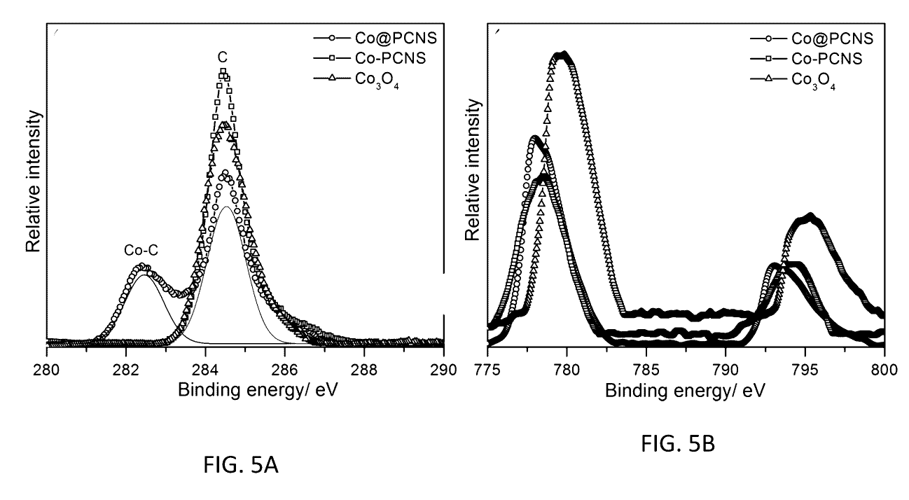

X-ray photoelectron spectra (XPS) of Co@PCNS sample were systematically investigated to gain further insight into the type of interaction between cobalt nanoparticles and carbon nanosheets. FIG. 5A shows C 1s XPS high resolution spectra of Co₃O₄, Co-PCNS and Co@PCNS samples. In FIG. 5A, Co-PCNS refers to physically mixed Co nanoparticles-carbon nanosheets composite. Referring to FIG. 5A, these high resolution spectra of Co₃O₄, Co-PCNS and Co@PCNS displayed main peak at 284.5 eV, which correspond to elemental carbon/sp² hybridized carbon from carbon nanosheets. The local bonding of Co nanoparticles on porous carbon nanosheet surface is evidenced by a low intensity Cls peak at 282.5 eV appeared for Co@PCNS sample, which can be assigned to Co—C bonds of cobalt carbide. Surface quantitative analysis using high resolution C is demonstrated that 20-25% of surface carbon atoms are bonded to Co atoms through Co—C bonds. This is also supported by the fact that most of the material is carbon nanosheets and Co—C alloying occurs only at the contact points of Co nanoparticles and carbon nanosheets. Such Co—C bonds are not present in Co@PCNS samples prepared at lower temperatures of 600 and 700° C., confirming that surface bonding through carbide bonds is definitely ensured at 800° C. FIG. 5B shows Co 2p XPS high-resolution spectra of Co₃O₄, Co-PCNS and Co@PCNS samples. As in FIG. 5A, Co-PCNS in FIG. 5B refers to physically mixed Co nanoparticles-carbon nanosheets composite. Referring to FIG. 5B, high resolution Co 2p spectra of Co₃O₄ contain of 2p_{3/2} and 2p_{1/2} components at 779.7 and 795.2 eV respectively, and their spin orbit splitting value of 15.5 eV are identical to spinel Co₃O₄ reported previously. Co 2p spectra of Co-PCNS sample displayed only characteristic signals of Co metal, which illustrated the phase purity of Co-PCNS. Co—C bond formation in Co@PCNS was further evidenced by their slightly lower Co 2p binding energies (778.10 and 793.53 eV respectively) compared to Co-PCNS.

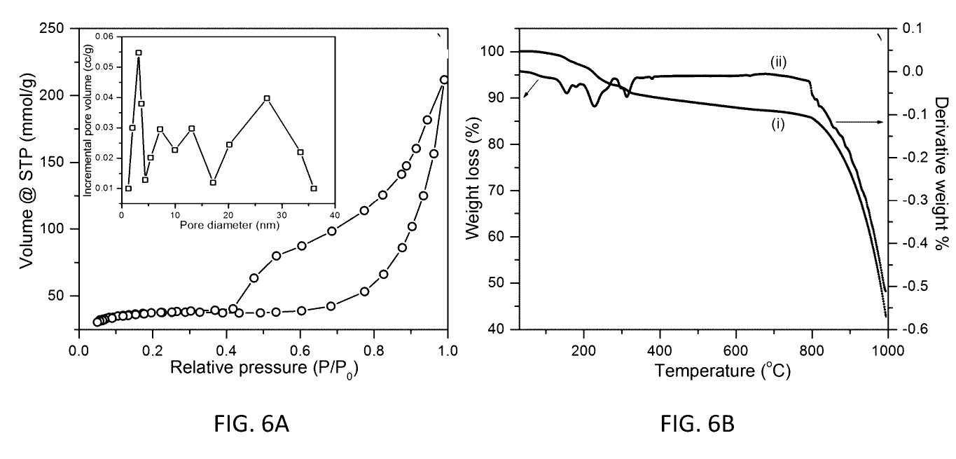

Thermogravimetric analysis (TGA) analysis of Co@PCNS under O₂ gas established that Co@PCNS contains ≈30% Co metal. Further investigation of the mesoporous microstructure was performed using N₂ adsorption desorption analysis. FIG. 6A shows N₂ adsorption-desorption isotherm and pore size distribution (inset of FIG. 6A) of Co-nanoparticles chemically bonded to porous carbon nanosheets. Referring to FIG. 6A, the isotherm of Co@PCNS displayed type III characteristics with H3 type of hysteresis. Porosity of carbon nanosheets are confirmed by the BJH pore size distribution, known to those skilled in the art (FIG. 6 inset), which is in good agreement with the high-resolution TEM results. These 2-30 nm sized mesopores are highly beneficial for achieving superior contact with an electrolyte, when Co@PCNS is used as an electrode in an electrochemical cell. TGA analysis of a mixture of Co(NO₃)₂.6H₂O, C₆H₁₂O₆ and NaCl under N₂ atmosphere was performed to follow mechanism of formation of Co@PCNS. FIG. 6B shows thermogravimetric analysis {graph labeled (i)} and differential thermal analysis {graph labeled (ii)} of Co@PCNS under N₂ atmosphere at a heating rate of 10° C./min. Referring to FIG. 6B, upon heating the mixture, first weight loss happened around 150° C. due to the removal of chemically bonded water from Co(NO₃)₂.6H₂O followed by its decomposition at 227° C. Third weight loss at 312° C. resulted from the carbonization of glucose into carbon. Final weight loss occurred around 800° C. can be assigned to the carbothermal reduction of Co-oxides into phase pure Co metal. Thus it can be concluded that simultaneous carbonization of glucose and in-situ decomposition of Co(NO₃)₂.6H₂O in presence of NaCl followed by the carbothermal reduction of Co oxides results in the formation of Co nanoparticles chemically bonded to porous carbon nanosheets. Crystallization of Co nanoparticles in the carbon matrix also prevented their agglomeration, which is a crucial factor deciding the electrochemical performance. This method is inexpensive and scalable, which can be easily extended for other transition metal based electrodes.

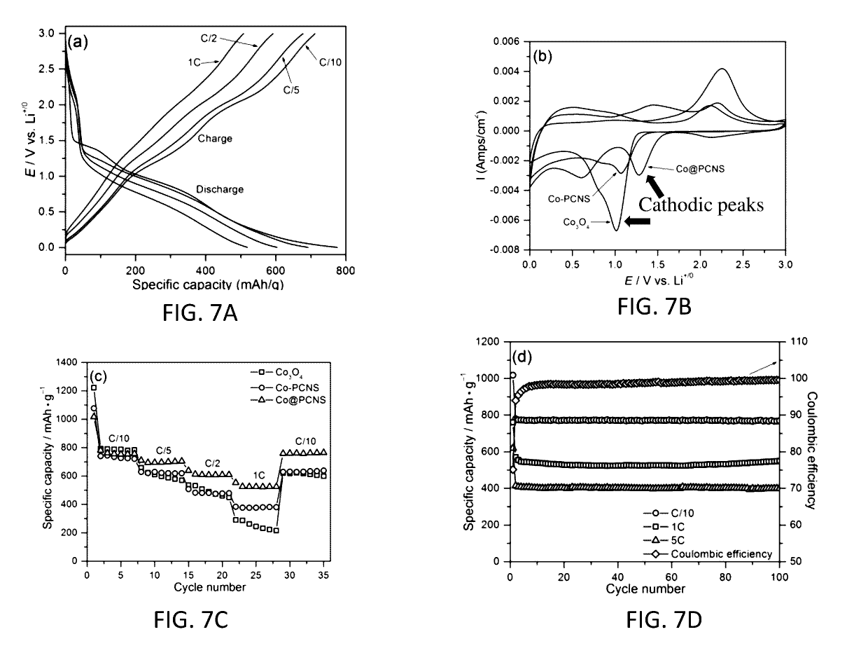

The 2D electrodes composed of Co nanoparticles chemically bonded on porous carbon nanosheets (Co@PCNS) demonstrated excellent Li-ion storage electrochemical performance compared to Co₃O₄ and a physically mixed Co nanoparticles/carbon nanosheets composite (Co-PCNS). Second galvanostatic charge and discharge profiles of Co@PCNS at various current densities are presented in FIG. 7A. Referring to FIG. 7A, Co@PCNS achieved specific capacities of 778 and 520 mAh/g at current densities of C/10 (37.2 mA/g) and 1C, respectively. Identical voltage profiles at various current densities are a clear indication of similar electrochemical processes at various charge-discharge rates. To obtain further details of the electrochemical processes, cyclic voltammetry (CV) of these samples are performed in the 3.0-0 V voltage range. First cathodic scan of Co₃O₄ corresponded to its reduction to Co metal by reaction with Li metal (Co₃O₄+8Li+8e⁻ [symbol] Co+4Li₂O+3Co). Similar cathodic signals of Co@PCNS and Co-PCNS represent the formation of nonstoichiometric Li—Co alloy, lithiation of amorphous carbon, and Solid Electrolyte Interface (SEI) formation. The difference between Co@PCNS and Co-PCNS samples is that lithiation of Co@PCNS happens at a 0.2 volt higher potential compared to the physically mixed sample, Co-PCNS. FIG. 7B shows second cycle cyclic voltammetry of Co@PCNS, Co3O4, and Co-PCNS. Referring to FIG. 7B, second cathodic peaks of Co@PCNS appeared at 1.27 V, which is slightly higher than those of Co-PCNS (1.07 V) and Co₃O₄ (1.01 V). Anodic peaks of Co—C hybrids also appeared at lower potentials compared to those of Co₃O₄ nanoparticles. These higher lithiation and lower delithiation potentials is a clear indication of faster Li-ion diffusion in chemically bonded Co-nanoparticles. Higher lithiation potentials for Co-PCNS can be related to the absence of Li₂O, a poor electronic conductor. Additionally, Co@PCNS benefit from Co—C bonds that aid lithiation of Co-nanoparticles at higher potentials.

All samples experienced irreversible capacity loss during the initial charge discharge cycle. Increased irreversible capacity loss for Co₃O₄ (36%) can be attributed to unavoidable formation of Li₂O and SEI during the first lithiation process. Nevertheless, only SEI formation contributed towards the 24% irreversible capacity of Co nanoparticles-carbon nanosheet hybrids. Different electrochemical processes in Co₃O₄ and Co@PCNS electrodes are also evident from this charge-discharge profile. A plateau around 1.0 V represents a phase change reaction of Co₃O₄ nanoparticles to Co metal. This plateau is absent in the case of Co@PCNS, and a sloping profile is characteristic of the direct lithiation of Co nanoparticles to form Li—Co alloy.

FIG. 7C shows electrochemical rate performance of Co @PCNS, Co₃O₄, and Co-PCNS. Referring to FIG. 7C, electrochemical rate performances of Co@PCNS are considerably higher than Co₃O₄ and Co-PCNS. At low current density of C/10, identical specific capacities are observed for Co₃O₄, Co-PCNS and Co@PCNS. However on increasing charge discharge rates, Co₃O₄ experienced severe capacity fading. For instance, at 1C rate, Co@PCNS, Co-PCNS, and Co₃O₄ electrodes demonstrated specific capacities of 520, 375 and 240 mAh/g, respectively. Even after cycling at higher current densities, only Co@PCNS regained a specific capacity of 770 mAh/g at C/10 rate. Charging rates denoted here are well understood by those of skill in the art; 1C rate means 1 hour of charging to attain full charge capacity, while C/10 rate means 10 hours of charging is required to attain full charge capacity.

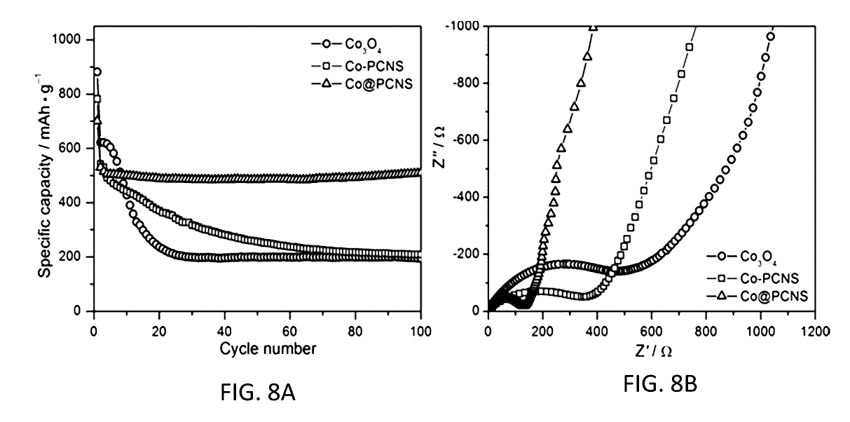

While long-term cycling stability is equally important to rate performance for practical battery operation, capacity retention of Co@PCNS for 100 galvanostatic cycles under various current densities was tested. FIG. 7D shows galvanostatic cycling performance of Co@PCNS at various current densities. Referring to FIG. 7D, independent of the charge-discharge rates, Co@PCNS retained 98% of the second discharge capacity after 100 galvanostatic cycles. Despite the high charge-discharge rate of 5C, Co@PCNS exhibited a stable specific capacity of 400 mAh/g, which is even higher than the maximum expected for graphite anodes (which is practically achieved only at very low discharge rates). Even at a high rate of 1C, Co@PCNS displayed a high coulombic efficiency of 99.6%, which is superior to the previous reports of conventional Co₃O₄ anodes. Electrochemical performances, especially cycling stability of these chemically bonded Co—C hybrid anodes are also superior to most promising high performance Co₃O₄ nanostructures reported previously. Under similar experimental conditions, Co₃O₄ nanoparticles and Co-PCNS experienced severe capacity fading up on prolonged galvanostatic cycling, as shown in FIG. 8A. Since Co@PCNS possess 2D microstructure, mesoporosity and Co—C bonds, it is necessary to differentiate the critical factor responsible for their exceptional electrochemical performance. For this, electrochemical impedance spectroscopy (EIS) of Co@PCNS was compared with Co-PCNS and Co₃O₄ nanoparticles. FIG. 8B shows electrochemical impedance spectra of Co@PCNS, Co3O4, and Co-PCNS electrodes. Referring to FIG. 8B, a strong correlation between EIS spectra and electrochemical performance of transition metal oxide electrodes was established previously. A high-frequency single semicircle and a low frequency sloping straight line of the Nyquist plots correspond to charge-transfer resistance (R_{ct}) and solid-state diffusion (Z_{w}) of Li-ions, respectively. The smallest charge transfer and solid-state diffusion resistance of Co@PCNS in contrast to Co-PCNS and Co₃O₄ is clearly observed from the EIS spectra. Reduced R_{ct} and Z_{w} of Co-PCNS compared to Co₃O₄ nanoparticles can be credited to its 2D morphology and mesoporous microstructure. By correlating the EIS spectra with rate performance and cycling stability of these samples, it can be concluded that Co—C local bonds are the primary factor responsible for the reduced charge-transfer/solid-state diffusion resistance and exceptional electrochemical performance of Co@PCNS electrodes. Chemical bonding of Co nanoparticles prevented their agglomeration, and nanosheets retained their structural integrity during numerous charge-discharge processes, which is greatly beneficial for long-term cycling stability. It should be noted that implementation of Co nanoparticles instead of Co₃O₄ avoided Li₂O formation, which is evidenced by the Raman spectra of Co@PCNS electrodes after 100 galvanostatic cycles.

Although 2D morphology and mesoporous microstructure are decisive factors for the improved electrochemical performance of Co-PCNS over Co₃O₄ nanoparticles, they are only secondary reasons for Co@PCNS. This fact is further substantiated by the poor electrochemical performances of Co@PCNS samples prepared at low temperatures devoid of any Co—C bonds. In the case of Co@PCNS, anchoring of Co-nanoparticles on carbon nanosheets through Co—C bonds prevents particle agglomeration and improves interfacial charge transfer/solid-state Li-ion diffusion. Nanosized Co particles enable the accommodation of huge volume change during electrochemical cycling. In addition, 2-D morphology and mesoporous microstructure of carbon nanosheets facilitate improved electrode-electrolyte contact, and strain relaxation. As mentioned in the literature, poor electrochemical performance of Co₃O₄ nanoparticles can be explained by their agglomeration into electrochemically inactive clusters, loss of electronic contact and Li₂O formation during lithiation. Although Co-PCNS contains mesopores and 2-D microstructure, lack of Co—C bonds adversely affects its electrochemical performance. Integration of multiple factors responsible for the improved electrochemical performance into a unique 2-D mesoporous microstructure made Co@PCNS an excellent anode material for rechargeable Li-ion batteries. The aqueous synthetic method described here is inexpensive and scalable, which can be easily extended for other transition metal electrodes for electrochemical energy storage.

In this disclosure unique 2D electrode architecture of cobalt nanoparticles chemically bonded to porous carbon nanosheets have been demonstrated These hybrid electrodes demonstrated outstanding rate capability and capacity retention compared to a physically mixed Co nanoparticles/carbon nanosheets composite (Co-PCNS) and a conventional Co₃O₄ electrode. The electrode microstructure reported herein possesses several advantages to improve the Li-ion storage electrochemical performance. Anchoring of Co nanoparticles on carbon nanosheets is beneficial for improved electronic contact and avoids their agglomeration during electrochemical cycling. In addition, mesoporosity of carbon nano sheet support enables improved strain relaxation during lithiation and delithiation of Co nanoparticles. Moreover, Co—C bonds facilitate efficient interfacial charge transfer between carbon nanosheets and Co nanoparticles. This disclosure demonstrates that the type of interaction between the active material and conducting carbon is a critical factor determining the electrochemical performance of Li-ion batteries. The high-performance chemically bonded Co@PCNS anode is a suitable candidate for replacing carbon based anodes in current generation Li-ion batteries.

Thus in this disclosure, hierarchically porous and 2D hybrid electrodes containing disordered carbon and Co/CoO nanoparticles are demonstrated as high-capacity anode for rechargeable Li-ion batteries. Cobalt-carbon hybrids are fabricated through a scalable and inexpensive method using starch/glucose as carbon precursor Co(NO3)2.6H2O as cobalt precursor. Interaction between Co nanoparticles and carbon support (chemical bonds or physical anchoring) are controlled by varying the processing temperature. These carbon-cobalt hybrid electrodes exhibited high specific capacities up to 1050 mAh/g (highest value reported for a transition metal based anode), excellent rate performance and outstanding cycling stabilities compared to the previous reports. Microscopic and spectroscopic investigation of the cobalt-carbon hybrid anodes after the electrochemical experiments illustrated their excellent mechanical and chemical stability. The significantly better electrochemical performance of the carbon nanosheet electrodes is attributed to the 2D morphology and pseudo-capacitive assisted Li-ion storage mechanism.

A 2D electrode architecture of ≈25 nm sized Co nanoparticles chemically bonded to ≈100 nm thick porous carbon nanosheets (Co@PCNS) is reported in this disclosure. Surface analysis using XPS and AFM proved strong anchoring of individual Co nanoparticles through Co—C bonds. When evaluated as anode materials, these hybrid electrodes exhibited exceptional rate performance and cycling stabilities compared to physically mixed Co nanoparticle/carbon nanosheet composite (Co-PCNS) and Co₃O₄ nanoparticles. Discharge capacity of 778 and 520 mAh/g, are achieved at current densities of 0.1 and 1C, respectively. Even at a high rate of 5C (1.86 A/g), Co@PCNS demonstrated a stable specific capacity of 400, mAh/g. In addition, 98% of the initial specific capacity was retained after 100 charge-discharge cycles at various current densities. Structural integrity of these electrodes is preserved after numerous charge-discharge cycles. In-situ formed Co—C bonds that improves interfacial charge transfer, and eliminate particle agglomeration are identified as the primary factor responsible for the exceptional electrochemical performance of Co@PCNS. Moreover, mesoporous microstructure and 2D morphology of supported carbon nanosheets facilitate superior contact with the electrolyte solution and improved strain relaxation.

Based on the above description, it is an objective of this disclosure to describe a method of making carbon sheets comprising nanosized metal particles. For purposes of this disclosure, such sheets are also described as carbon sheets “decorated” with metal particles. The method includes dissolving a quantity of sodium chloride, a quantity of a salt containing the metal, and a quantity of glucose into water, such that the ratio of weight of sodium chloride and the weight of glucose is in the range of 1-8, resulting in a homogeneous aqueous solution of the sodium chloride, the glucose and the salt of the metal. The resulting homogeneous aqueous solution is then dried at a temperature in the range of 80-100° C., resulting in a homogeneous powder containing sodium chloride, glucose and the salt of the metal. The homogeneous powder is then heated to a heating temperature in an inert atmosphere for a time period resulting in a composite comprising carbon sheets containing sodium chloride and nanoparticles of the metal. The composite containing carbon sheet containing sodium chloride and nanoparticles of the metal is cooled to room temperature (typically in the range of 20-35° C.) and removing sodium chloride by dissolving the composite in water resulting in carbon sheets containing nanoparticles of the metal. As demonstrated and described earlier, carbon sheets comprising nanosized metal particles made by this method contain mesoporosity.

It should be recognized that maintaining the ratio of weight of sodium chloride and the weight of glucose in the range of 1-8 is advantageous in ensuring a sheet structure for the carbon formed during the heating step. Glucose used in the experiments of this disclosure had the chemical formula C₆H₁₂O₆. However other sugars and carbohydrates can be used. Non-limiting examples of sugars that can be used include, but not limited to, C₁₂H₂₂O₁₁ (Disaccharide/Sucrose), C₁₂H₂₂O₁₁ (Lactose), and C₆H₁₀O₅ (starch).

It should be recognized that various embodiments of the above described method are possible. In some embodiments the metal is cobalt, an electrochemically active metal. The salt of the metal mentioned in the method above is the source for the nanoparticles of the metal. When the metal in the method is cobalt, the salt of the metal can be one of cobalt nitrate, cobalt acetate, and cobalt chloride. When utilizing cobalt nitrate as the salt of the cobalt metal, the weight ratio of cobalt (II) nitrate hexahydrate (Co(NO₃)₂.6H₂O) to glucose (C₆H₁₂O₆) can be varied from 0.8 to 0.2. This ratio directly affects the amount of Co nanoparticles loading. The ratio in the range 0.8-0.2 helps to avoid aggregation of cobalt nanoparticles after lithium intake (battery charging). An ideal scenario is when cobalt nanoparticles are decorated in a fashion that they stay apart around 10 nm distance on the surface of carbon. The reason behind it is to avoid aggregation after lithium intake (battery charging). Higher concentration of cobalt than indicated by this ratio can lead aggregation and pulverization (electrode peeling off) which may adversely affect battery performance during repeated charge-discharge of batteries.

In some embodiments of the method using cobalt as the metal, a no-limiting range for the size of the nanoparticles of cobalt is 5-30 nm. A non-limiting range for the heating temperature mentioned in the method is 600-900° C., while a non-limiting range for the time period is in the range of 1-5 hours. As described earlier, In some embodiments the metal of the method is an electrochemically active metal. Examples of electrochemically active metals suitable for this method include, but are not limited to, cobalt, iron, antimony, tin, nickel, manganese and tungsten.

Based on the above descriptions, it is another objective of this disclosure to describe carbon sheet with 2D morphology containing nanosized metal particles. In one embodiment this carbon sheet contains mesoporosity. In several embodiments the metal is an electrochemically active metal. Examples of electrochemically active metals suitable for this purpose include, but are not limited to cobalt, iron, antimony, tin, nickel, manganese and tungsten. In a preferred embodiment of the carbon sheet 2D morphology containing nanosized metal particles, the metal is cobalt and the nanosized cobalt particles are covalently bonded to the carbon sheet forming a Co—C bond. In one such embodiment, the nanoparticles of cobalt are in the size range of 5-30 nm.

Based on the above descriptions, and experimental results discussed, it is another objective of this disclosure to describe electrode comprising a carbon sheet with 2D morphology containing nanosized metal particles. As described above the carbon sheet in the electrode can contain mesoporosity. In some embodiments of the electrode comprising a carbon sheet with 2D morphology containing nanosized metal particles, the metal is an electrochemically active metal. Examples of electrochemically active metals suitable for this purpose include, but are not limited to cobalt, iron, antimony, tin, nickel, manganese and tungsten. In a preferred embodiment, the electrode comprises a carbon sheet with 2D morphology containing nanosized cobalt particles, wherein the nanosized cobalt particles are covalently bonded to the carbon sheet forming a Co—C bond. In one embodiment of this electrode containing nanosized cobalt particles, the nanoparticles of cobalt are in the size range of 5-30 nm.

The electrodes of this disclosure described above can be advantageously used as anodes in electrochemical energy storage cells. Thus, based on the above description, it is yet another objective of this disclosure to describe an electrochemical storage cell containing an anode comprising a carbon sheet with 2D morphology containing nanosized metal particles. In one embodiment the cell the cell is a Li-ion cell. In one embodiment of the Li-ion cell, the carbon sheet contains mesoporosity. In some embodiments of the Li-ion cell containing an anode comprising a carbon sheet with 2D morphology containing nanosized metal particles, the metal is an electrochemically active metal. Examples of electrochemically active metals suitable for this purpose include, but are not limited to cobalt, iron, antimony, tin, nickel, manganese and tungsten. In a preferred embodiment of the Li-ion cell, the anode comprises a carbon sheet with 2D morphology containing nanosized cobalt particles, wherein the nanosized cobalt particles are covalently bonded to the carbon sheet forming a Co—C bond. In one embodiment of Li-ion cell containing an anode comprising a carbon sheet with 2D morphology containing nanosized metal particles containing nano sized cobalt particles, the nanoparticles of cobalt are in the size range of 5-30 nm.

While the present disclosure has been described with reference to certain embodiments, it will be apparent to those of ordinary skill in the art that other embodiments and implementations are possible that are within the scope of the present disclosure without departing from the spirit and scope of the present disclosure. Thus, the implementations should not be limited to the particular limitations described. Other implementations may be possible. It is therefore intended that the foregoing detailed description be regarded as illustrative rather than limiting. Thus, this disclosure is limited only by the following claims.

1. A method of making carbon sheets comprising nanosized metal particles, the method comprising:
dissolving a quantity of sodium chloride, a quantity of a salt containing the metal, and a quantity of glucose into water, such that the ratio of weight of the sodium chloride and weight of the glucose is in the range of 1-8, resulting in a homogeneous aqueous solution of the sodium chloride, the glucose and the salt of the metal;
drying the homogeneous aqueous solution at a temperature in the range of 80-100 degrees centigrade, resulting in a homogeneous powder containing the sodium chloride, the glucose and the salt of the metal;
heating the homogeneous powder at a heating temperature in an inert atmosphere for a time period resulting in a composite comprising carbon sheets containing the sodium chloride and nanoparticles of the metal; and
cooling the composite containing carbon sheet containing the sodium chloride and nanoparticles of the metal to room temperature and removing sodium chloride by dissolving the composite in water resulting in carbon sheets containing nanoparticles of the metal.

2. The method of claim 1, wherein the metal is cobalt and the metal salt is one of cobalt nitrate, cobalt chloride and cobalt acetate.

3. The method of claim 1, wherein the nanoparticles of cobalt are in the size range of 5-30 nm.

4. The method of claim 1, wherein the heating temperatures is in the range of 600-900° C.

5. The method of claim 1, wherein the time period is in the range of 1-5 hours.

6. The method of claim 1, wherein the carbon sheets contain mesoporosity.

7. The method of claim 1, wherein the metal is one of iron, antimony, tin, nickel, manganese and tungsten.

8. A carbon sheet with 2D morphology containing nanosized metal particles.

9. The carbon sheet of claim 8, wherein the metal is an electrochemically active metal.

10. The carbon sheet of claim 8, wherein the electrochemically active metal is cobalt and the nanosized cobalt particles are covalently bonded to the carbon sheet forming a Co—C bond.

11. The carbon sheet of claim 10, wherein the nanoparticles of cobalt are in the size range of 5-30 nm.

12. The carbon sheet of claim 8, wherein the carbon sheet contains mesoporosity.

13. The carbon sheet of claim 9, wherein the electrochemically active metal is one of iron, antimony, tin, nickel, manganese and tungsten.

14. An electrode comprising a carbon sheet with 2D morphology containing nanosized metal particles.

15. The electrode of claim 14, wherein the metal is an electrochemically active metal.

16. The electrode of claim 15, wherein the electrochemically active metal is cobalt and the nanosized cobalt particles are covalently bonded to the carbon sheet forming a Co—C bond.

17. The electrode of claim 16, wherein the nanoparticles of cobalt are in the size range of 5-30 nm.

18. The electrode of claim 14, the carbon sheet contains mesoporosity.

19. The electrode of claim 15, wherein the electrochemically active metal is one of iron, antimony, tin, nickel, manganese and tungsten.

20. An electrochemical storage cell containing an anode comprising a carbon sheet with 2D morphology containing nanosized metal particles.

21. The electrochemical storage cell of claim 20, wherein the cell is a Li-ion cell.

22. The electrochemical storage cell of claim 20, wherein the metal is an electrochemically active metal.

23. The electrochemical storage cell of claim 22, wherein the electrochemically active metal is cobalt and the nanosized cobalt particles are covalently bonded to the carbon sheet forming a Co—C bond.

24. The electrochemical storage cell of claim 23, wherein the nanosized particles of cobalt are in the size range of 5-30 nm.

25. The electrochemical storage cell of claim 20, wherein the carbon sheet contains mesoporosity.

26. The electrochemical storage cell of claim 22, wherein the electrochemically active metal is one of iron, antimony, tin, nickel, manganese and tungsten.
